(19) United States
(12) Patent Application Publication
(10) Pub. No.: US 2005/0035950 A1
(43) Pub. Date: Feb. 17, 2005

(54) Portable input device for computer

(76) Inventor: Ted Daniels, Nampa, ID (US)

Correspondence Address: PERKINS COIE LLP;PATENT-SEA, P.O. BOX 1247, SEATTLE, WA, 98111-1247, US

(21) Appl. No.: 10/949,149

(22) Filed: Sep. 23, 2004

Related U.S. Application Data
(63) Continuation of application No. 09/420,787, filed on Oct. 19, 1999.

(51) Int. Cl. G09G 5/00

(52) U.S. Cl. 345/169

(57) ABSTRACT

A method and apparatus are provided for improving the functionality of a remote input device while allowing for the input device to perform a number of roles. This is achieved by providing a detachable keyboard within a portable computer capable of functioning as both a hardwired, internal input device and as a remote, wireless input device. The input device of the invention is capable of being housed within a portable computer and performs as a typical on-board input device. In addition, the input device may be removed from the base of the computer and used as an internally-powered wireless control device. In the latter mode the communication between the input device and the computer takes place through a wireless link existing between the input device and the computer.

### BACKGROUND OF THE INVENTION

1. Field of the Invention

This invention relates to portable computers and, more particularly, to data input devices for use with portable computers.

2. Description of the Related Art

Portable computers have proven to be popular in domestic, business and industrial environments due to the unrestricted freedom of movement they offer users. In addition, portable computers, also called laptop computers, have rapidly become a ubiquitous and useful tool in informational presentations, particularly multimedia presentations. Such multimedia presentations are most often performed through the use of a portable computer connected to a projector displaying an image on a screen. The computer controls the operation of the projector as well as the content on the screen.

A typical portable computer is shown in FIG. 6. A portable computer 500 generally includes a display screen 502, e.g. a liquid crystal display (“LCD”), which is attached by hinge mechanisms 503 to a base 504. The base 504 includes a central processor unit (“CPU”), non-volatile and volatile memory, and a battery power supply (not shown). The base 504 also includes a keyboard 506, and a mouse/trackball pointing unit 508 in the form of a small projection from keyboard 506 and mouse click switches 509. A portable computer 500 may also have a number of optional components such as, for example, disk drive 510, PMCIA card slot 512, and speakers 514 within the base 504 or display screen 502.

To facilitate multimedia presentations, the portable computer 500 may also have a series of connectors 516 located on the outer side or back surface of the portable computer 500. The portable computer 500 communicates with a presentation unit, e.g. a slide projector (not shown), through a hardwired connection from the presentation unit to a connector 516. Alternatively, the communication may occur using wireless communication.

Although the use of a portable computer 500 is more efficient than using a standard desktop computer in many cases, the user is still required to be physically proximate to the portable computer 500 to operate it. The ability to move around during a presentation or, at the least, choose your own seat is highly desirable. Prior solutions to this problem generally involve the purchase of separate computer peripherals capable of exercising remote control over the portable computer 500.

One solution has been the use of a mouse or similar peripheral device to control a presentation using a sufficiently long cord attached to the computer 500. However, such peripherals are limited in their use since the user is relegated to only a rolling mouse or a “point and click” interface. Another solution has been the use of a second keyboard attached to the computer 500 through a hardwired connection to connector 516. This can also be accomplished using a wireless connection, that is, the physical hard wire connection between a conventional keyboard and computer 500 is replaced by, for example, an infrared link. Control signals are thus transmitted from the keyboard to the computer 500 through an infrared link. The infrared link may be built into the computer 500 or, more commonly, is an additional peripheral which is purchased and then connected to a connector 516.

Currently, if the additional convenience of a remote input device is needed, a user must invest both time and money. This is often done at some sacrifice to usability and function due to the extra equipment and setup required to use such devices. Consequently, when such a system is used, additional equipment must be transported and reduced functionality is experienced in comparison to on-board input devices.

### SUMMARY OF THE INVENTION

The present invention provides a method and apparatus for improving the functionality of a remote input device while allowing for the input device to perform a number of roles. This is achieved by providing a detachable keyboard within a portable computer capable of functioning as both a hardwired, internal keyboard input device and as a remote, wireless keyboard input device. The keyboard input device of the invention is capable of being housed within a portable computer and performs as a typical hardwired on-board keyboard input device. In addition, the input device may be removed from the base of the computer and used as an internally-powered wireless keyboard input device. In the latter mode the communication between the keyboard input device and the computer takes place through a wireless link, possibly through infrared signals.

### BRIEF DESCRIPTION OF THE DRAWINGS

The foregoing and other advantages and features of the invention will become more apparent from the detailed description of embodiments given below with reference to the accompanying drawings, in which:

FIG. 1 illustrates a portable computer system;

FIG. 2 illustrates a block diagram of the portable computer system of FIG. 1 in a wireless mode of operation;

FIG. 3 is a block diagram of a keyboard constructed in accordance with the invention;

FIGS. 4a-4b are block diagrams of infrared systems according to an embodiment of the invention;

FIG. 5 is a flow chart of a method of operating the invention; and

FIG. 6 illustrates a prior art portable computer.

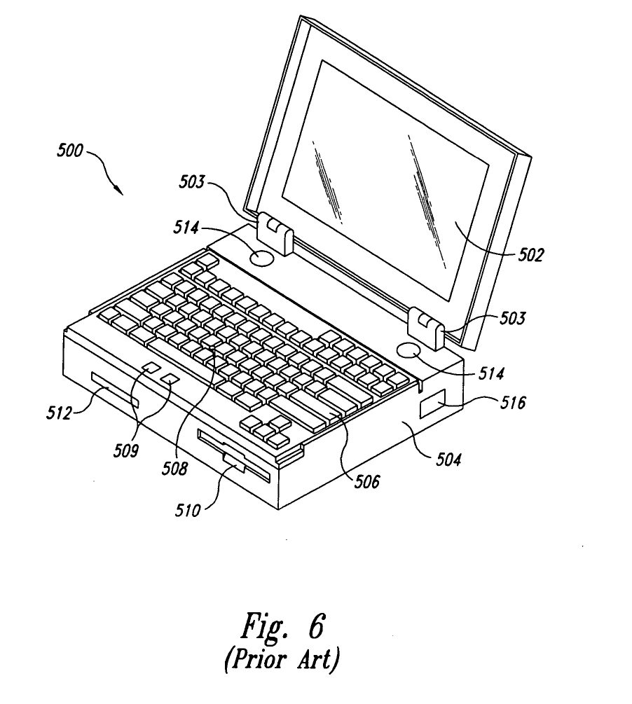

### DETAILED DESCRIPTION OF PREFERRED EMBODIMENTS

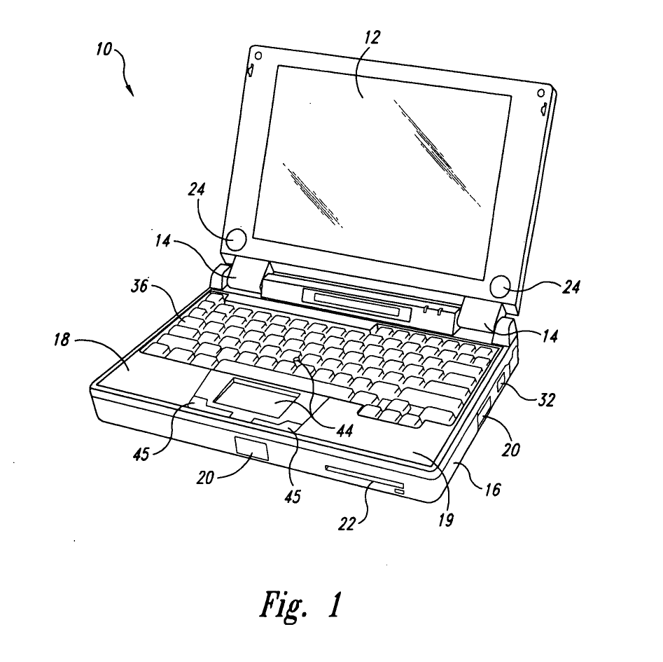

An embodiment of the present invention will now be described with reference to FIGS. 1-5. Other embodiments may be realized and structural, electrical, or logical changes may be made to and equivalents used for the disclosed embodiment without departing from the spirit or scope of the present invention.

FIG. 1 depicts a portable computer 10 constructed in accordance with an embodiment of the invention. The computer 10 includes a display screen 12, e.g. a liquid crystal display (“LCD”), which is attached by hinge mechanisms 14 to a base 16. The base 16 includes at least a central processor unit (“CPU”), non-volatile and volatile memory, and a battery power supply (not shown). The base 16 also includes a keyboard input device 18. The illustrated keyboard input device 18 may operate over a hardwired connection (or another fixed signal interface) and a wireless link to the base 16 through wireless input/output transducers 20. FIG. 1 shows the computer 10 operating with keyboard input device 18 through a signal interface, e.g. in a hardwired mode, infrared (IR) mode, radio frequency (RF) mode, or other mode. The computer 10 may also have a number of optional conventional components such as, for example, disk drive 22, speakers 24, CD-ROM drive, DVD drive, etc.

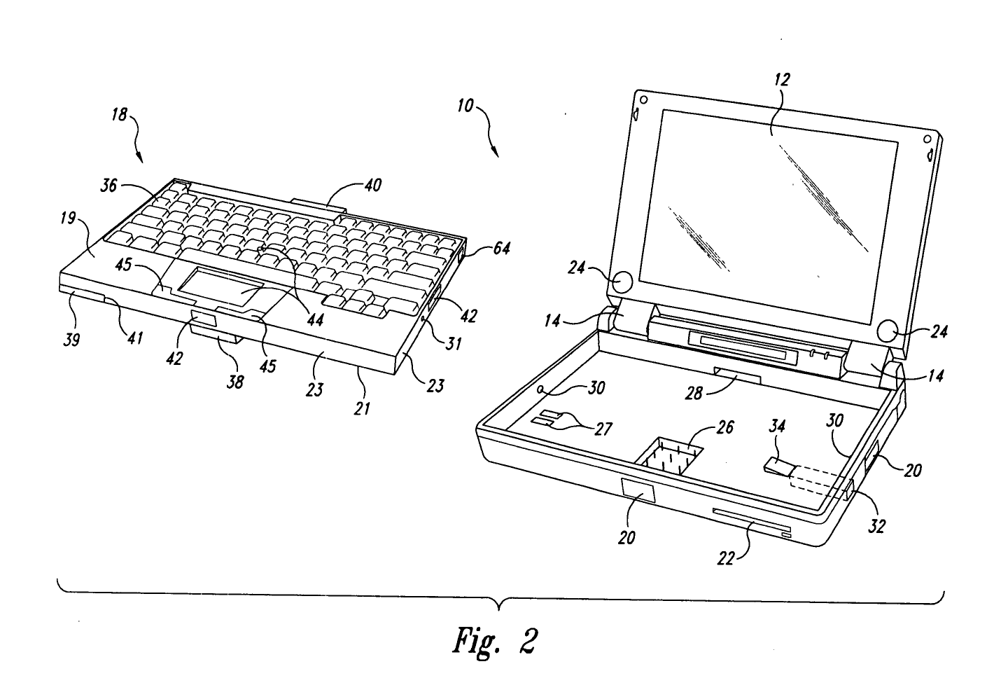

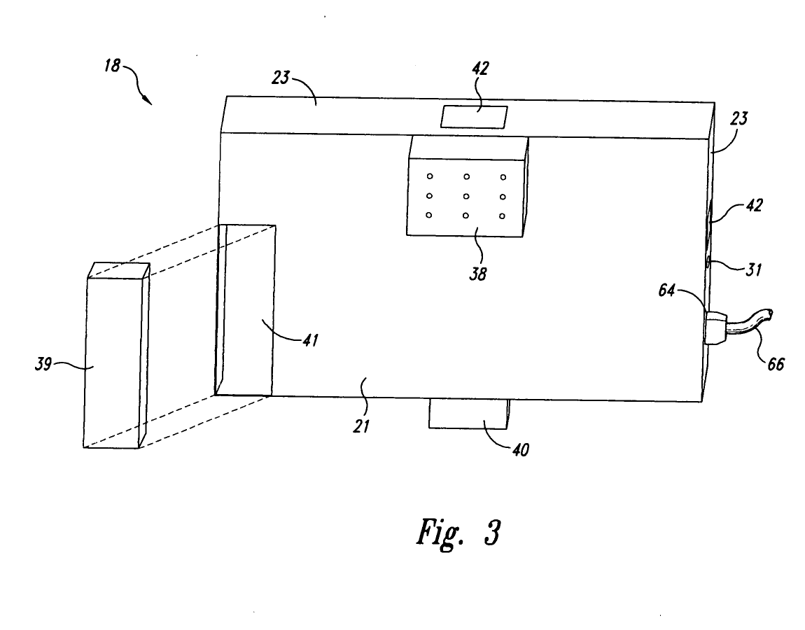

FIGS. 2 and 3 show input device 18 operating in a wireless mode after having been removed from the base 16 of computer 10. As seen in FIG. 2, the computer 10 further comprises a hardwire connector 26, electrical contacts 27, a slot 28, a recess 29 capable of holding keyboard input device 18, and at least two retainer devices 30 (one of which is partially hidden in FIG. 2 by the right sidewall of recess 29). Retainer devices 30 may be any mechanical biasing device which places pressure on the edges of input device 18 to prevent the movement of input device 18 in a vertical direction when it is seated in recess 29. The retainer devices 30 may be spring-loaded ball bearings. The retainer devices 30 may also be fitted into concave grooves 31 in the sides of keyboard input device 18 when keyboard input device 18 is seated in recess 29. The base 16 is also equipped with an eject mechanism 34 to aid in the removal of keyboard input device 18 from base 16. The eject mechanism 34 is activated by trigger 32 to place an upward force sufficient to overcome the biasing force of the retainer devices 30 on the keyboard input device 18, thus allowing for easy removal of keyboard input device 18 from recess 29.

The keyboard input device 18 comprises a wireless keyboard having a plurality of keys 36, a hardwire connector 38 which engages with connector 26 when the keyboard input device 18 is seated in recess 29, at least one removable battery 39, and a tab 40 which is insertable in slot 28 to help hold the keyboard input device 18 in place in recess 29. Keyboard input device 18 preferably has an upper surface 19, a lower surface 21, and four sides 23 perpendicular to the upper and lower surfaces 19, 21 and at least one infrared input/output transducer 42 provided at one or more locations on at least two sides 23 of keyboard input device 18, as shown in FIGS. 2 and 3. Additionally, the keyboard input device 18 may be equipped with a pointing device 44 and at least two click switches 45 for enabling the usual “mouse click” inputs. Internally the input device 18 is equipped with a microprocessor unit (MPU) (not shown) to control the functions of the keyboard input device 18. Pointing device 44 and click switches 45 perform the function of a computer mouse and may be provided in the form of a track ball apparatus, a touch pad apparatus, or other form of pointing device known in the art.

Hardwire connectors 26 and 38 are constructed to mate so that when keyboard input device 18 is operating in a hardwired mode the connectors 26 and 38 interlock and electronically couple to allow signals to pass between the keyboard input device 18 and the base 16. Hardwire connectors 26 and 38 may be a male/female pin-type connector pair where either the connector 26 is male and the connector 38 is female, or vice versa. Similarly, slot 28 and tab 40 are designed to engage and mate with one another to assist in the securing of keyboard input device 18 within base 16. Slot 28 extends from the back wall of recess 29 toward the outer surface of base 16 by a distance equal to that of the length of tab 40. Eject mechanism 34 may be a physically actuated device responsive to a force applied to trigger 32. Eject mechanism 34 may be constructed as a simple lever device wherein command pressure on trigger 32 forces eject mechanism 34 to project up from the bottom of recess 29, or as an electrically actuated solenoid device, depending upon the space and power requirements of the computer 10.

Power to the keyboard input device 18 is supplied through a direct connection to the base 16 or through a battery 39 depending upon the communication state of the computer 10. Removable battery 39 is located within keyboard input device 18 in slot or recess 41. In a hardwired communication state where the input device 18 is secured within recess 29, power is supplied to the input device 18 through a hardwired connection to base 16. This hardwired connection may be incorporated into connectors 26 and 38 or may be accomplished through the mating of electrical contacts 27 and battery 39.

Battery 39 may be a rechargeable battery pack, e.g. a metal hydride or lithium ion battery. Alternatively, keyboard input device 18 includes alternating current (AC) power input 64 as shown in FIG. 3. AC power input 64 is capable of receiving power through an AC power adapter cord 66. This embodiment may be desirable to decrease reliance on battery 39 when keyboard input device 18 is operating remotely. The connection between electrical contacts 27 and the battery 39 is also active when input unit 18 is secured in base 16 in order to charge battery 39. When the input device 18 is removed from the base 16 and is communicating in a wireless state, power is supplied to input device 18 through battery 39.

For establishing communications between the base 16 and the input device 18, a plurality of wireless transducers 20 and 42 are provided on the base 16 and keyboard input device 18, respectively. The base 16 may be equipped with at least three transducers 20 on at least three different edges of the base 16. Similarly, there may be at least three transducers 42 located on three different edges of the input unit 18. Such an arrangement will ensure reliable communication between the base 16 and the input device 18, especially in cases where no two transducers 20, 42 are perfectly sight-aligned. The present invention may employ an infrared or radio frequency (RF) communication link between transducers 20 and 42. Infrared communication links are known in the art, such as the one described in U.S. Pat. No. 4,628,541 which is incorporated herein by reference.

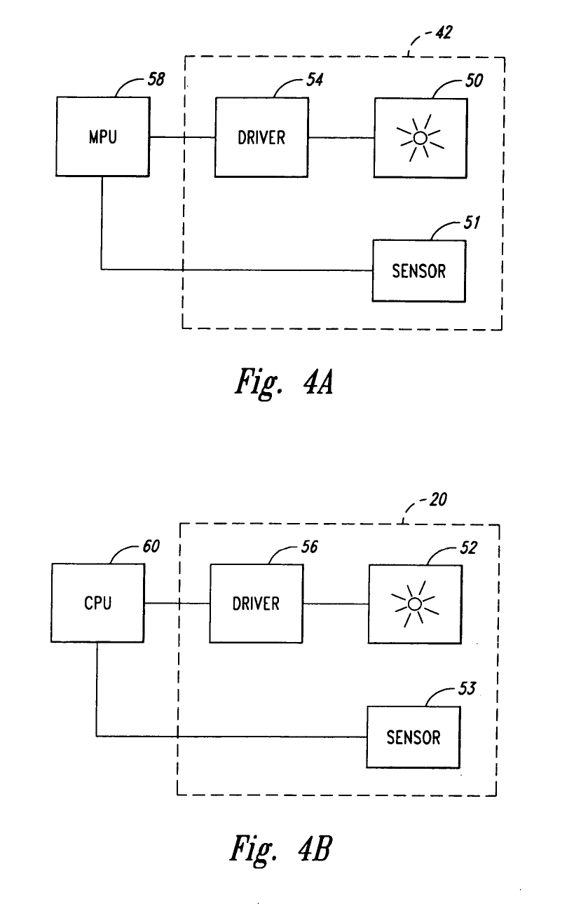

Infrared wireless communication is conducted between keyboard input device 18 and base 16 through the transmission and reception of signals between transducer 42 and transducer 20, as shown in FIGS. 4a and 4b. Each one of the transducers 42, 20 may include respective transmitters 50, 52, possibly light emitting diodes (LED) operating in the infrared range, LED drivers 54, 56 to drive LEDs 50, 52 and sensors 51, 53 to sense incoming signals. The drivers 54, 56 are controlled by processors MPU 58 and CPU 60 which are the processing units respectively contained within the keyboard input device 18 and base 16, as described above. Sensors 51, 53 may be sensors capable of receiving light having a wavelength in the infrared region and converting this received light into electric signals.

Since the keyboard input device 18 does not generally require any outside data to be operational, transducer 42 may be solely a transmitter having only driver 54 and LED 50 and transducer 20 may be solely a receiver having only sensor 53. Such an arrangement would be simple and cost-effective compared to a bi-directional infrared transmission system. However, either system may be used in the invention.

To prevent confusion with other infrared or wireless devices which may be in nearby operation, the present invention may attach a unique identification (ID) code to outgoing infrared signals. In use, the infrared transducer 42 transmits data signals originating from the keys 36, pointing device 44, or click switches 45 with an accompanying ID code. The combined signal is transmitted by transducer 42 through a series of light pulses from LED 50. The transducer 20 of the base 16 receives the signal using sensor 53 and transmits the combined signal to CPU 60. CPU 60 isolates the ID code and compares the received ID code with a reference ID code. If the two ID codes are identical, CPU 60 to accepts that the data signal originated from keyboard input device 18 and not from another device using infrared transmission, e.g. a television remote control.

In operation, the computer 10 is capable of operating in at least installed and remote communication modes. In one embodiment of the installed mode, the keyboard input device 18 is secured within depression 29 of the base 16. Tab 40 is within slot 28, battery 39 is electrically connected to electrical contacts 27, hardwire connector 26 is coupled to hardwire connector 38, and eject mechanism 34 is in a pre-eject state. In addition, retainer devices 30 are engaged to provide pressure on the edges of keyboard input device 18, further securing it from movement within recess 29. In the installed mode, the input device 18 may be in communication with the CPU of base 16 through a suitable signal interface such as hardwire connectors 38, 26 and powered by the power source of base 16. Although wireless communication is possible in this state if an additional transducer 20 were to be placed inside the recess 29, hardwired communication may be desirable in some circumstances because it consumes less power.

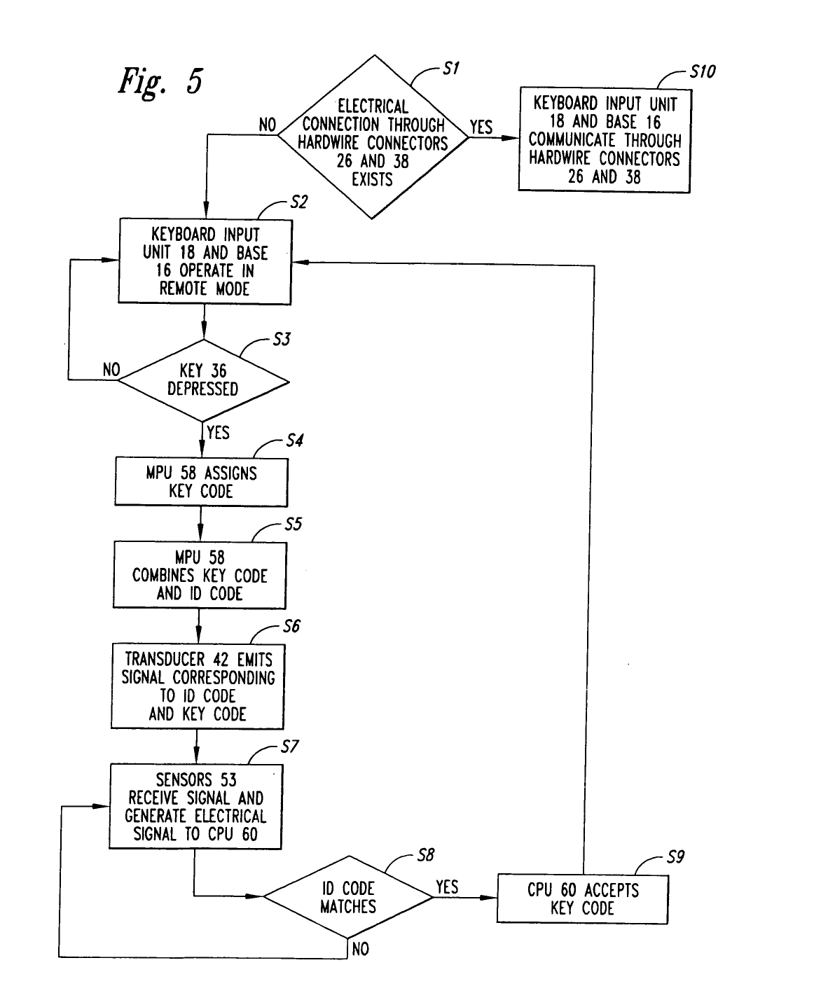

A remote communication mode may be started in a number of ways. The computer 10 may enter the remote communication mode upon the activation of eject mechanism 34 using trigger 32 as shown in the flow chart of FIG. 5. This may be accomplished by the constant monitoring of hardwire connector 38 by the MPU 58 of input device 18, as in process segment S1. Upon detection of a break in the electrical connection with hardwire connector 26, the MPU 58 of the keyboard input device 18 begins operating in remote mode, as in process segment S2. Another method for determining whether a hardwired connection exists is through an electronic signal sent to the keyboard input device 18 and base 16, either through a software-based command or a specialized key 36 or other button located on the base 16 or keyboard input device 18.

Once a remote communication mode is entered, the keyboard input device 18 may be used remotely from the base 16 at a distance and location defined by the strength and location of the transducers 42. If a key 36 is depressed or the pointing device 44 is used, as in process segment S3, the MPU 58 of the keyboard input device 18 assigns a key code to the depressed key according to its position on the keyboard input device 18, as in process segment S4. The MPU 58 of input device 18 then combines the key code with the ID code unique to computer 10, as in process segment S5. The transducer 42, through the infrared driver 54 and LED 50, emits the key code and ID code signal, as in process segment S6.

Sensors 53 of transducers 20 receive the infrared signals from transducer 42 and output a corresponding electrical signal to the CPU 60 of base 16, as in process segment S7. Next the CPU 60 determines if the received ID code matches the predetermined ID code corresponding to keyboard input device 18, as in process segment S8. If the ID code of the received signal does not match the predetermined ID code, the received signal is rejected and the base 16 continues to monitor for signals, as in process segment S7. If the ID code of the received signal matches the predetermined ID code, the received signal is accepted by the CPU 60 of the base 16 as a direction from keyboard input device 18, as in process segment S9. In the embodiment in which the transducers 20 and 42 are capable of communication in a bi-directional mode, transmission from the base 16 and reception by the keyboard input device 18 is performed in a similar manner.

If the hardwired connection between connectors 26 and 38 exists, communication between the base 16 and the keyboard input device 18 is conducted by the transfer of electrical signals through connectors 26 and 38, as in process segment S10.

It should be readily apparent that although only one method of transmitting wireless signals using an infrared system has been described for purposes of simplicity, any infrared, RF, or other wireless form of communication may be used. For example, transmitter 50 and sensor 53 may be an RF transmitter and an RF sensoring device. In addition, although the removable input device has been disclosed as a removable keyboard input device 18, the invention can also be applied to other removable input devices of a portable computer, such as a removable mouse. Furthermore, the invention may be successfully implemented within computer environments, not solely portable computers. For example, the present invention may be employed in special use computers such as personal digital assistants.

While the invention has been described in detail in connection with embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Accordingly, the invention is not to be seen as limited by the foregoing description, but is only limited by the scope of the appended claims.

1. A portable personal computer, comprising:
a base having a controller for controlling operations thereof;
a display attached to said base; and
a removable wireless input device for communicating with said controller in said base through a signal interface when mounted into said base or through a wireless connection when removed from said base.

2-44. (Canceled)
